(19) United States
(12) Patent Application Publication
(10) Pub. No.: US 2017/0111899 A1
(43) Pub. Date: Apr. 20, 2017

(54) TRANSMITTING CONTROL INFORMATION FOR CARRIER AGGREGATED SPECTRUMS

(71) Applicant: InterDigital Patent Holdings, Inc., Wilmington, DE (US)

(72) Inventors: Kyle Jung-Lin Pan, Saint James, NY (US); Philip J. Pietraski, Jericho, NY (US); Jean-Louis Gauvreau, La Prairie (CA)

(73) Assignee: InterDigital Patent Holdings, Inc., Wilmington, DE (US)

(21) Appl. No.: 15/391,426

(22) Filed: Dec. 27, 2016

Related U.S. Application Data
(63) Continuation of application No. 12/763,770, filed on Apr. 20, 2010.
(60) Provisional application No. 61/171,609, filed on Apr. 22, 2009.

(51) Int. Cl. H04W 72/04

(52) U.S. Cl. CPC H04W 72/0413; H04W 72/042; H04W 84/042

(57) ABSTRACT

A transceiver may receive a plurality of codewords on a plurality of physical downlink shared channels (PDSCHs) on a plurality of downlink component carriers. A processor may send, using a physical uplink control channel (PUCCH) transmission, an indication as to whether each of the plurality of codewords is being acknowledged (ACK) or negatively acknowledged (NACK). The transceiver may transmit a first PUCCH transmission on a first uplink carrier and a second PUCCH transmission on a second uplink carrier.

### CROSS REFERENCE TO RELATED APPLICATIONS

This application is a continuation of U.S. patent application Ser. No. 12/763,770 filed Apr. 20, 2010, which claims the benefit of U.S. provisional application No. 61/171,609 filed Apr. 22, 2009, which is incorporated by reference as if fully set forth herein.

### FIELD OF INVENTION

This application is related to wireless communications.

### BACKGROUND

Long Term Evolution (LTE) supports data rates up to 100 Mbps in the downlink and 50 Mbps in the uplink. LTE-Advanced (LTE-A) provides a fivefold improvement in downlink data rates relative to LTE using, among other techniques, carrier aggregation. Carrier aggregation may support, for example, flexible bandwidth assignments up to 100 MHz. Carriers are known as component carriers in LTE-A. A wireless transmit/receive unit (WTRU) may simultaneously receive one or more component carriers.

LTE-A may operate in symmetric and asymmetric configurations with respect to component carrier size and the number of component carriers. This is supported through the use or aggregation of up to five 20 MHz component carriers. For example, a single contiguous downlink (DL) 40 MHz aggregation of multiple component carriers may be paired with a single 15 MHz uplink (UL) component carrier. Non-contiguous LTE-A DL aggregate carrier assignments may therefore not correspond with an UL aggregate carrier assignment.

Aggregate carrier bandwidth may be contiguous, where multiple adjacent component carriers may occupy continuous 10, 40 or 60 MHz. Aggregate carrier bandwidth may also be non-contiguous, where one aggregate carrier may be built from more than one, but not necessarily adjacent component carriers. For example, a first DL component carrier of 15 MHz may be aggregated with a second non-adjacent DL component carrier of 10 MHz, yielding an overall 25 MHz aggregate bandwidth. Moreover, component carriers may be situated at varying pairing distances. For example, the 15 and 10 MHz component carriers may be separated by 30 MHz, or in another setting, by only 20 MHz. As such, the number, size and continuity of component carriers may be different in the UL and DL.

The WTRU may need to transmit uplink control information (UCI) to a base station. LTE methods for transmitting UCI may not account for multiple component carriers as used in carrier aggregation. UCI transmission methods may need to account for symmetric and asymmetric configurations, where it may be possible to assign multiple component carriers in the uplink (UL), downlink (DL) or both.

### SUMMARY

Methods and apparatus for transmitting uplink control information (UCI) in carrier aggregated spectrums are disclosed. UCI may include, but is not limited to, Precoding Matrix Indicator (PMI), Rank Indication (RI), Channel Quality Indicator (CQI), Acknowledge/Not Acknowledge (ACK/NACK) and Scheduling Request (SR). For symmetric carrier aggregation, uplink (UL) and downlink (DL) component carriers may be paired and may use physical uplink control channel (PUCCH) in each UL component carrier to send UCI for the corresponding DL component carrier. For asymmetric carrier aggregation, methods are provided for UCI transmission and resource allocation depending on component carrier configuration or assignment. Methods are provided for multiple and single component carrier configurations that may further provide backward compatibility.

### BRIEF DESCRIPTION OF THE DRAWINGS

A more detailed understanding may be had from the following description, given by way of example in conjunction with the accompanying drawings wherein:

FIG. 1 is an embodiment of a wireless communication system/access network of long term evolution (LTE) and/or LTE-Advanced (LTE-A);

FIG. 2 are example block diagrams of a wireless transmit/receive unit (WTRU) and a base station of the LTE and/or LTE-A wireless communication system;

FIG. 3 shows an example of wireless communications using component carriers;

FIG. 4 shows an example Uplink/Downlink (UL/DL) carrier association using described rules for 5 DL component carriers and 3 UL component carriers;

FIG. 5 shows another example UL/DL carrier association using described rules for 5 DL component carriers and 3 UL component carriers;

FIG. 6 shows another example UL/DL carrier association using WTRU specific anchor carrier or primary carrier and described rules for 5 DL component carriers and 3 UL component carriers;

FIG. 7 shows an example physical uplink control channel (PUCCH) method for transmitting Uplink Control Information (UCI) for type 1 and type 2 UCI groups in multiple UL component carriers;

FIG. 8 shows an example timing diagram for UCI transmission for type 1 and type 2 UCI group for 5 DL component carriers and 3 UL component carriers;

FIGS. 9(a)-(d) show examples of timing diagrams for UCI transmission for type 2 UCI group for 5 DL component carriers and a single UL primary component carrier;

FIG. 10 shows an example physical uplink shared channel (PUSCH) method for transmitting UCIs for type 2 UCI group and PUCCH for transmitting UCI for type 1 UCI group;

FIG. 11 shows an example of a new PUCCH format;

FIG. 12 shows an example flowchart for transmitting UCI from a WTRU to a base station; and

FIG. 13 shows another example flowchart for transmitting UCI from a WTRU to a base station.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, evolved Node-B (eNB), a site controller, an access point (AP), or any other type of interfacing device capable of operating in a wireless environment.

In general, uplink control information (UCI) may include, but is not limited to, Precoding Matrix Indicator (PMI), Rank Indication (RI), Channel Quality Indicator (CQI), Acknowledge/Not Acknowledge (ACK/NACK) and Scheduling Request (SR). The WTRU sends the UCI to the base station. The base station acts in accordance with the type of UCI received. For example, the base station may make determinations or adjustments to channel power, carrier allocation, transmission power, time-frequency resource allocation, multiple-input multiple-output (MIMO) parameters, hybrid automatic repeat request (HARQ) processes, and other similar parameters.

In long term evolution (LTE), certain associated Layer 1/Layer 2 (L1/2) control signalling, such as those included in UCI, may be needed to support uplink (UL) transmissions, downlink (DL) transmissions, scheduling, multiple-input multiple-output (MIMO), and other functionality. If the WTRU has not been assigned an UL resource for UL data transmission (such as a physical uplink shared channel (PUSCH)), then the L1/2 UCI is transmitted in an UL resource specially assigned for UL L1/2 control such as on a physical uplink control channel (PUCCH). These PUCCH resources are located at the edges of the total available cell bandwidth (BW).

In LTE, UCI in subframe n is transmitted on PUCCH using format 1/1a/1b or 2/2a/2b if the WTRU is not transmitting on PUSCH in subframe n. UCI in subframe n is transmitted on PUSCH if the WTRU is transmitting on PUSCH in subframe n unless the PUSCH transmission corresponds to a Random Access Response Grant or a retransmission of the same transport block as part of the contention based random access procedure, in which case the UCI is not transmitted. Hereafter, subframes are numbered in monotonically increasing order; if the last subframe of a radio frame is denoted k, the first subframe of the next radio frame is denoted k+1.

The following combinations of UCI on PUCCH are supported in LTE: HARQ-ACK using PUCCH format 1a or 1b; HARQ-ACK using PUCCH format 1b with channel selection; SR using PUCCH format 1; HARQ-ACK and SR using PUCCH format 1a or 1b; CQI using PUCCH format 2; CQI and HARQ-ACK using either PUCCH formats 2a or 2b for normal cyclic prefix, or format 2 for extended cyclic prefix. CQI/PMI or RI may be transmitted periodically via PUCCH using format 2. ACK/NACK may be transmitted in subframe n if there is a corresponding physical downlink shared channel (PDSCH) in subframe n−4. If ACK/NACK is present with CQI/PMI or RI in the same subframe, ACK/NACK may be multiplexed with CQI/PMI or RI using format 2a or 2b depending on whether one or two codewords was received. If ACK/NACK is present and CQI/PMI or RI is not present in the subframe, ACK/NACK is sent via PUCCH using format 1a or 1b depending on whether one or two codewords was received. Multiple component carriers in the UL and DL as used in carrier aggregation may require additional methods for reporting UCI.

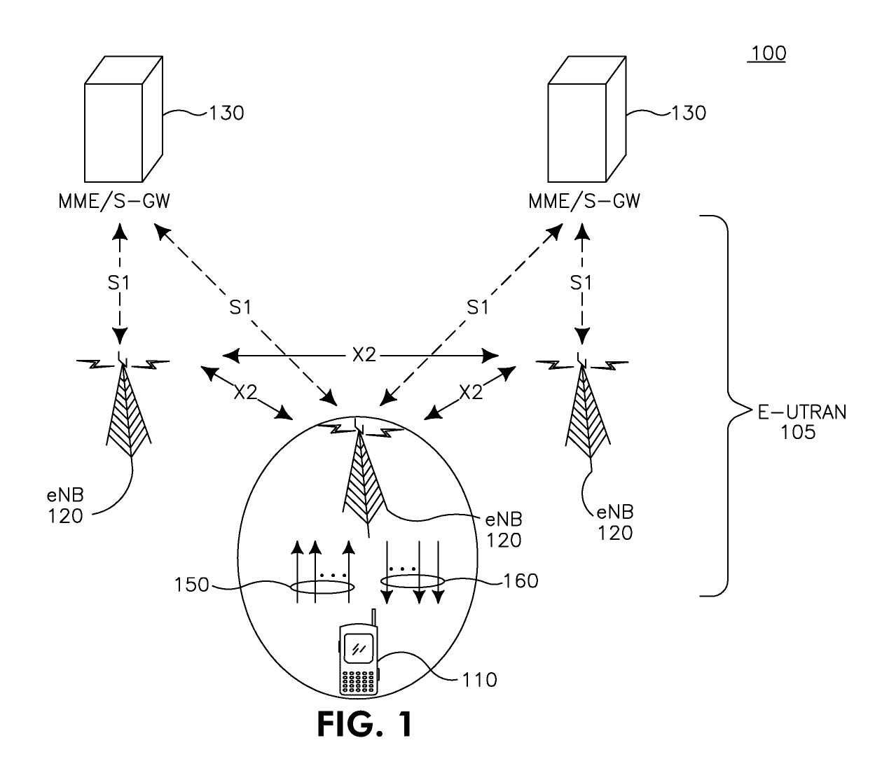

Methods and apparatus for transmitting UCI in carrier aggregated spectrums are disclosed herein. FIG. 1 shows a Long Term Evolution (LTE) and/or LTE-Advanced (LTE-A) wireless communication system/access network 100 that includes an Evolved-Universal Terrestrial Radio Access Network (E-UTRAN) 105. The E-UTRAN 105 includes several evolved Node-Bs, (eNBs) 120. The WTRU 110 is in communication with an eNB 120. The WTRU 110 and eNB 120 may communicate using UL component carriers 150 and DL component carriers 160. The eNBs 120 interface with each other using an X2 interface. Each of the eNBs 120 interface with a Mobility Management Entity (MME)/Serving GateWay (S-GW) 130 through an S1 interface. Although a single WTRU 110 and three eNBs 120 are shown in FIG. 1, it should be apparent that any combination of wireless and wired devices may be included in the wireless communication system access network 100.

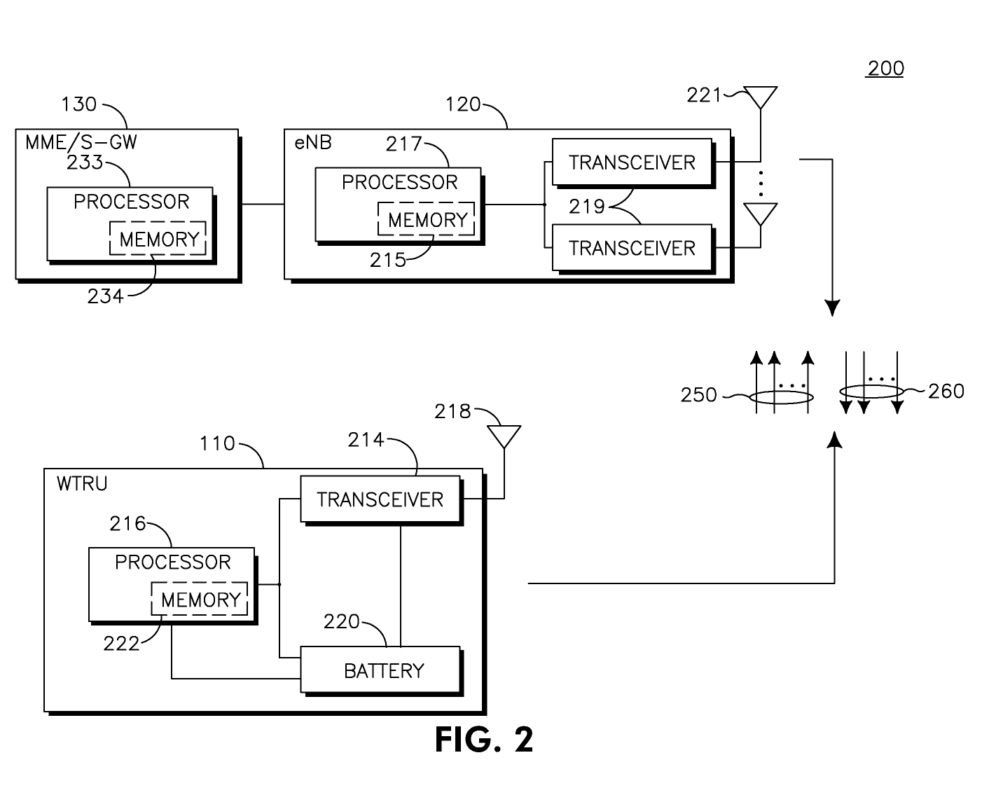

FIG. 2 is an example block diagram of an LTE or LTE-A wireless communication system 200 including the WTRU 110, the eNB 120, and the MME/S-GW 130. As shown in FIG. 1, the WTRU 110 is in communication with the eNB 120 and both are configured to support UL transmissions from the WTRU 110 which are transmitted to the eNB 120 using multiple component carriers 250, and downlink transmissions from the eNB 120 which are transmitted to the WTRU 110 using multiple DL carriers 260. As shown in FIG. 2, the WTRU 110, the eNB 120 and the MME/S-GW 130 are configured to transmit UCI for carrier aggregated spectrums.

In addition to the components that may be found in a typical WTRU, the WTRU 110 includes a processor 216 with an optional linked memory 222, at least one transceiver 214, an optional battery 220, and an antenna 218. The processor 216 is configured to support transmission of UCI for carrier aggregated spectrums. The transceiver 214 is in communication with the processor 216 and the antenna 218 to facilitate the transmission and reception of wireless communications. In case a battery 220 is used in the WTRU 110, it powers the transceiver 214 and the processor 216.

In addition to the components that may be found in a typical eNB, the eNB 120 includes a processor 217 with an optional linked memory 215, transceivers 219, and antennas 221. The processor 217 is configured to support transmission of UCI for carrier aggregated spectrums. The transceivers 219 are in communication with the processor 217 and antennas 221 to facilitate the transmission and reception of wireless communications. The eNB 120 is connected to the MME/S-GW 130 which includes a processor 233 with an optional linked memory 234.

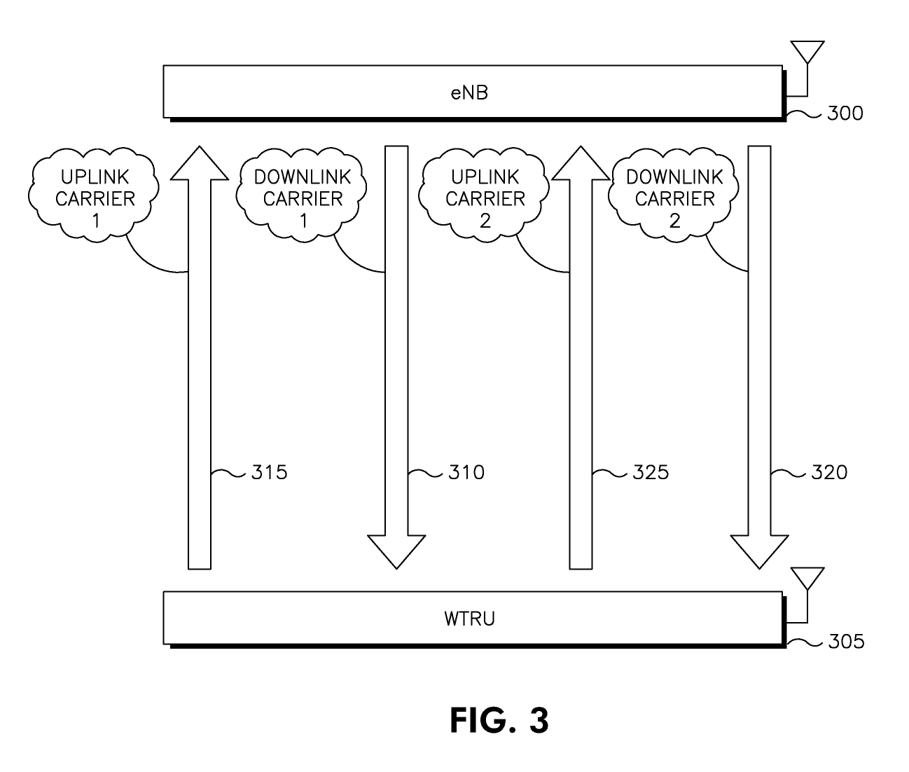

FIG. 3 shows an example of multiple component carriers being transmitted and received between eNB 300 and WTRU 305. For example, the multiple component carriers may include DL component carrier 1 310, DL component carrier 2 320, UL component carrier 1 315 and UL component carrier 2 325. UL component carrier 1 315 and UL component carrier 2 325 may carry PUCCH(s) and PUSCH(s) having UCI as described herein. The WTRU 305 sends the UCI to the eNB 300. The eNB 300 behaves in accordance with the type of UCI received. The eNB 300 may make determinations or adjustments to channel power, carrier allocation, transmission power, time-frequency resource allocation, multiple-input multiple-output (MIMO) parameters, hybrid automatic repeat request (HARQ) processes, and other similar parameters in response to the received UCI parameters.

In general, the WTRU may transmit the UCI in one UL component carrier or multiple UL component carriers for symmetric or asymmetric carrier aggregation. The UL component carrier may be an UL primary component carrier. For example, the WTRU may transmit the UCI in a PUCCH in one UL primary component carrier. The PUCCH in a UL component carrier may not, however, accommodate all the UCIs corresponding to multiple DL component carriers. In these cases, the WTRU may use methods including but not limited to, bundling, multiplexing, joint coding or combinations thereof to transmit the UCI over one or multiple PUCCHs.

Multiple ACKs or NACKs are jointly coded using block coding such as Reed Muller coding, simplex coding, or convolutional coding. The jointly encoded ACK/NACKs are transmitted using PUCCH format 1a with binary phase shift keying (BPSK), 1b with quadrature phase shift keying (QPSK), or format 2, 2a or 2b. Multiple ACKs or NACKs may also be either fully or partially bundled such that only a single ACK or NACK may be generated and transmitted if full bundling is performed or fewer ACKs or NACKs are generated and transmitted if partial bundling is used.

As disclosed herein, the WTRU may also use the PUSCH in periodic or aperiodic modes, or combined PUCCH and PUSCH to transmit UCIs in a single UL component carrier or multiple UL component carriers.

Disclosed herein are WTRU UCI transmission methods using a single UL primary component carrier or multiple UL component carriers for symmetric and asymmetric configurations. These methods include, but are not limited to, PUCCH, PUCCH in combination with bundling, PUCCH in combination with multiplexing, PUCCH in combination with bundling and multiplexing, PUCCH in combination with joint coding using PUCCH format 1a/1b or format 2/2a/2b or other new PUCCH formats, periodic PUSCH, aperiodic PUSCH, periodic PUSCH in combination with aperiodic PUSCH, PUCCH in combination with PUSCH and other illustrative methods.

For asymmetric carrier aggregation in which there are more configured DL carriers than UL component carriers, the WTRU may use UCI grouping in conjunction with single or multiple PUCCH(s) with combined joint coding, multiplexing or bundling techniques, periodic or aperiodic PUSCH, or combinations of PUCCH and PUSCH to transmit the UCI. In this case, the WTRU may use a two step procedure to send the UCI. First, the WTRU associates UL component carriers with DL component carriers and creates UCI groups with different types for UCI transmission purposes as described herein. Second, the WTRU uses periodic PUCCH for type 1 UCI groups and uses periodic PUSCH, PUCCH or combination of PUCCH/PUSCH for transmitting UCIs corresponding to multiple DL carriers for type 2 UCI groups. Type 1 UCI and type 2 UCI groups are described herein.

Methods for the WTRU to associate the UL component carriers or PUCCH (or PUSCH) with DL component carriers and create UCI groups with different types for UCI transmission are now described. If the WTRU determines that DL component carriers are associated with an UL component carrier for UCI transmission, then the WTRU associates those DL/UL component carriers together. These DL/UL associations are categorized as UCI groups by the WTRU. For UCI transmission purposes, UCI groups are categorized into two types.

For the multiple UL component carrier case, a type 1 UCI group contains one UL component carrier and one DL component carrier and a type 2 UCI group contains one UL component carrier but multiple DL component carriers. A type 1 UCI group may be a type of symmetric component carrier association and a type 2 UCI group may be a type of asymmetric component carrier association.

When the single UL primary component carrier case is used to transmit UCI, PUCCH (or PUSCH) may be associated with one DL component carrier or one PUCCH (or PUSCH) may be associated with multiple DL component carriers. Depending on the association of PUCCH and/or PUSCH with DL component carriers, the WTRU uses different transmission techniques including joint coding, multiplexing, bundling, or combinations of the different transmission techniques. WTRU feedback mode(s) may be determined based on the association between PUCCH and/or PUSCH with DL component carriers.

For UL/DL component carrier association and UCI grouping, the WTRU may consider two options. For option 1, the WTRU may use the same UL/DL carrier association rule used for both UCI grouping/transmission and downlink control information (DCI) transmission. Example association rules and grouping for DCI transmission are described in U.S. application Ser. No. 12/723,308, filed Mar. 12, 2012, titled “Uplink Grant, Downlink Assignment And Search Space Method And Apparatus in Carrier Aggregation”, which is incorporated by reference as if fully set forth herein. For option 2, the WTRU may use separate and independent UL/DL carrier association rules for UCI grouping/transmission and DCI transmission. Independent association rules may enable the most flexibility and optimization for the system but also may entail more complexity. Example association rules and grouping for UCI transmission are described herein.

In a first option for UL/DL carrier association and UCI grouping, the WTRU may use the same UL/DL carrier association rule for both UCI and DCI transmission. In order to indicate which UL component carrier that an UL grant is intended, the UL component carrier may be associated with a DL component carrier in such way that if an UL grant is transmitted in a DL component carrier x, then the UL grant is intended for an UL component carrier y where a mapping function f( ) that maps a DL component carrier x to UL component carrier y by y=f(x). Such a mapping may also be used by the WTRU for UCI reporting. That is, the WTRU may transmit the UCI for DL component carrier x in UL component carrier y, where y=f(x).

In an alternative association rule, the WTRU may transmit UCI for DL component carrier x in UL component carrier z, where z=g(x). The function g( ) may be an association rule or mapping function for UCI transmission. Association rule or mapping function g( ) may be different from f( ). The WTRU may transmit UCI for DL component carrier x in UL component carrier z, while an UL grant transmitted in DL component carrier x may be intended for UL carrier y, where UL component carrier y may not be equal to UL component carrier z.

In a second option for UL/DL carrier association and UCI grouping, the WTRU may use separate and independent UL/DL carrier association rules for UCI and DCI transmission.

The following example association rules (AR) are provided for UCI transmissions assuming that there are more DL component carriers than UL component carriers. The WTRU may use the ARs with respect to the transmission of the UCI. In a first AR (AR1), UL-DL component carriers may first be associated using an one-to-one mapping for as many UL-DL component carriers as possible with leaving one UL component carrier unassociated. The last UL component carrier is then associated with all the remaining DL carriers that are not associated with any UL component carriers. This will create one or multiple type 1 UCI groups and/or one type 2 UCI group.

In a second AR (AR2), a maximum number of DL component carriers that may be in one association group or UCI group is first determined. For example, if the maximum is two, then a maximum of two DL component carriers may be associated with one UL component carrier. The reason for doing this is to facilitate techniques such as component carrier ACK/NACK joint coding, ACK/NACK bundling, ACK/NACK multiplexing or channel selection, UCI joint coding, UCI bundling or UCI multiplexing. The more component carriers' ACK/NACKs or UCIs that may be bundled, the more degradation that may be caused or the more difficultly in fitting the ACK/NACK bits or UCI bits (either jointly or individually coded) in a fixed PUCCH payload. By limiting the number of component carriers' ACK/NACKs or UCIs that may be bundled or multiplexed, performance degradation or time delay may be minimized. After determining the maximum number of DL component carriers that may be associated in one group, DL component carriers may be associated with each UL component carrier in accordance with the determination step. One or multiple type 2 UCI groups and/or type 1 UCI groups may then be established.

In a third AR (AR3), association may be determined by an UL primary component carrier. A maximum number of DL component carriers that may be in one association group or UCI group is first determined. Such a maximum number may be based on the maximum number of component carriers that may be activated or configured simultaneously in the same subframe. The maximum number of DL component carriers may then be associated that may be in one association group or UCI group to a WTRU specific UL primary carrier. This association is semi-static, since the UL primary carrier may change over time. Some UL component carriers may be left unassociated with DL component carriers and may be used as secondary UL carriers for data transmission but not for control transmission.

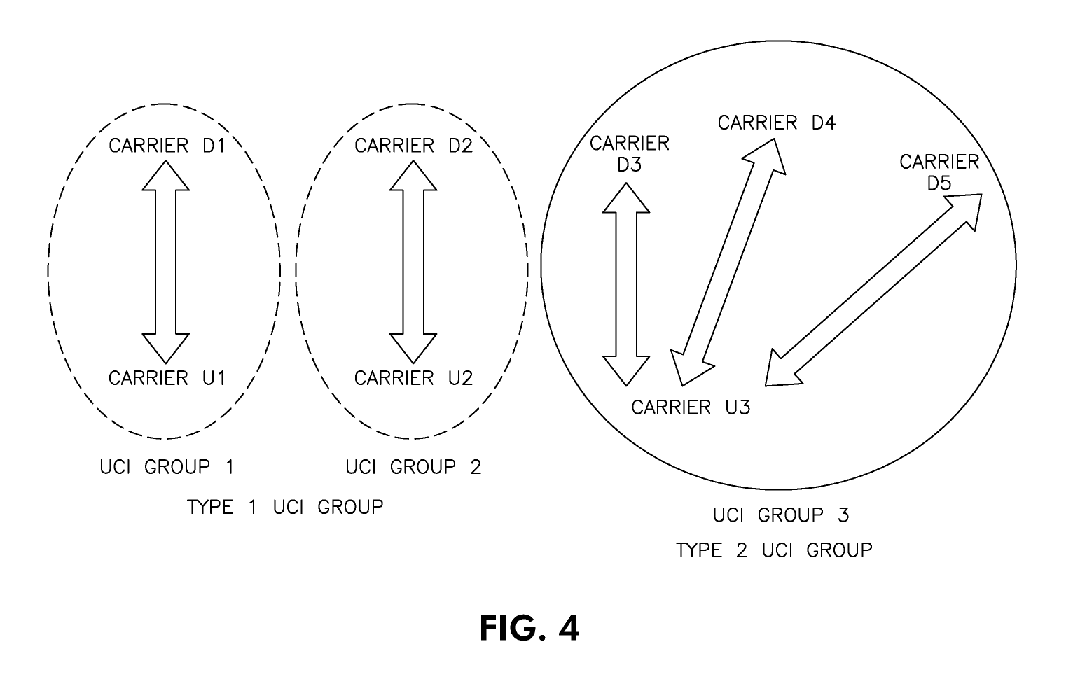

An example of UL/DL carrier association using AR1 is shown in FIG. 4. Carrier D1, Carrier D2, Carrier D3, Carrier D4 and Carrier D5 denote DL component carriers 1, 2, 3, 4 and 5, respectively. Carrier U1, Carrier U2 and Carrier U3 denote UL component carriers 1, 2 and 3, respectively. In this case, Carrier D1 and Carrier U1 form association group 1 or UCI group 1. Carrier D2 and Carrier U2 form association group 2 or UCI group 2. Carrier D3, Carrier D4, Carrier D5 and Carrier U3 form association group 3 or UCI group 3.

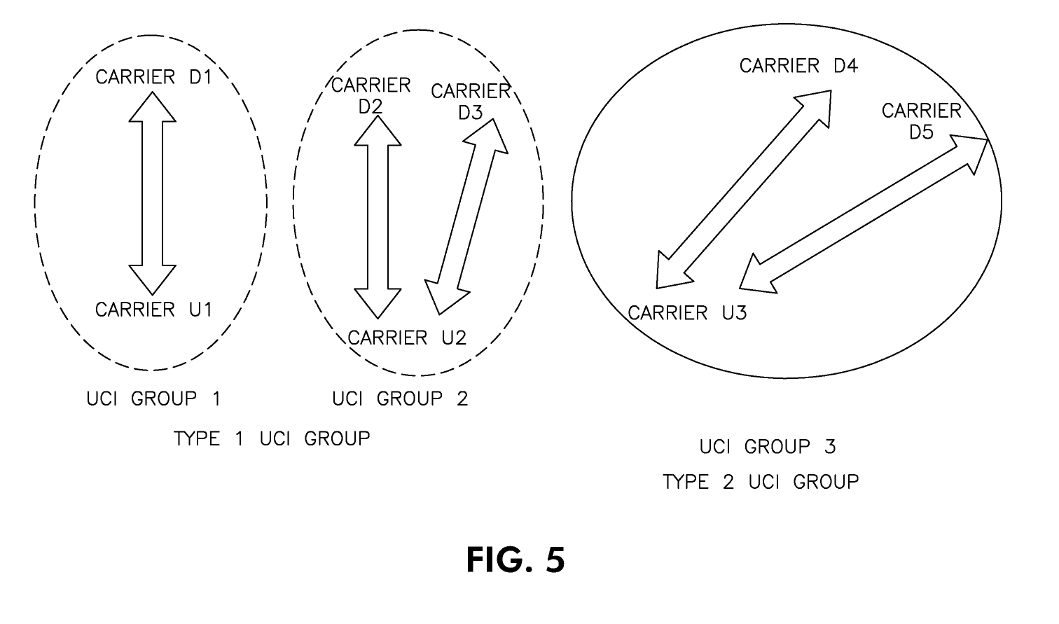

An example of UL/DL carrier association using AR2 is shown in FIG. 5. Carrier D1 and Carrier U1 form association group 1 or UCI group 1. Carrier D2, Carrier D3 and Carrier U2 form association group 2 or UCI group 2. Carrier D4, Carrier D5 and Carrier U3 form association group 3 or UCI group 3.

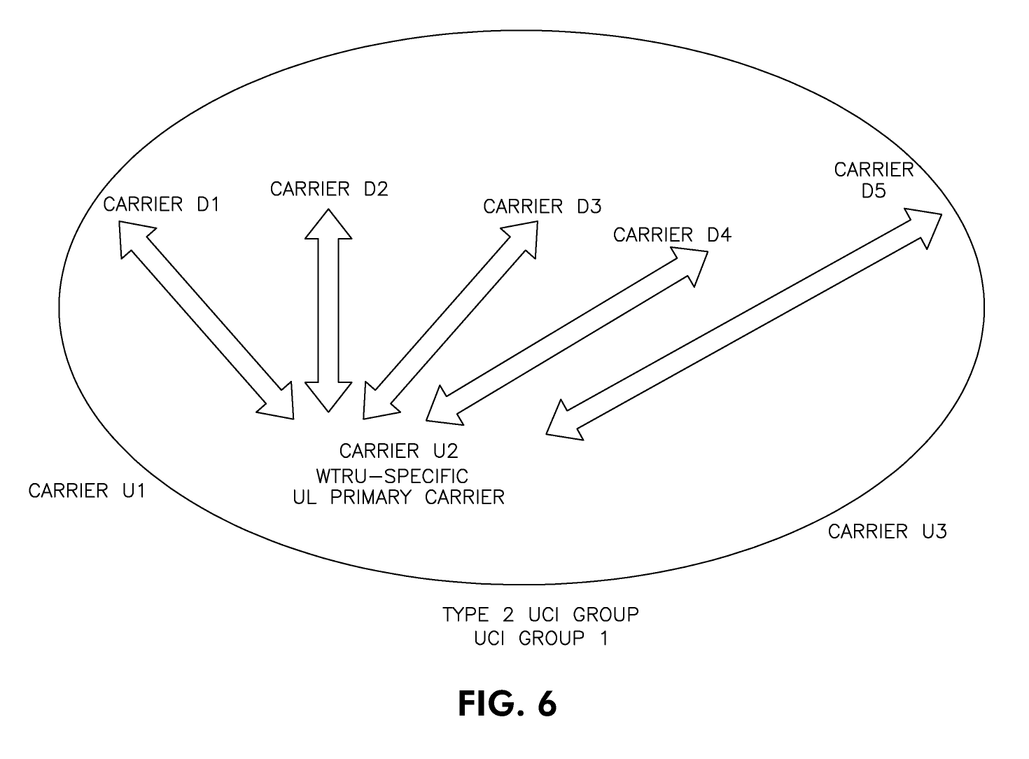

An example of UL/DL carrier association using AR3 is shown in FIG. 6. Carrier D1, Carrier D2, Carrier D3, Carrier D4 and Carrier D5 are associated with the WTRU specific UL primary Carrier U2 to form UCI group 1. Carrier U1 and U3 are not associated with any DL carrier. Other association or mapping rules for UCI transmission may be applied in accordance with the teachings described herein.

In general, the WTRU may transmit the UCI in the UL carrier corresponding to the DL carrier or carriers that are in the same association group or UCI group. For UCI transmission purposes, UCI groups are categorized into either a type 1 UCI group, where the UCI group contains one UL component carrier and one DL component carrier; or a type 2 UCI group, where an UCI group contains a single UL component carrier but multiple DL component carriers. For example, as shown in FIG. 4, UCI group 1 and UCI group 2 are type 1 UCI group and UCI group 3 is a type 2 UCI group. In another example, as shown in FIG. 5, UCI group 1 is a type 1 UCI group and UCI group 2 and UCI group 3 are type 2 UCI groups. As described herein, periodic PUCCH may be used for type 1 UCI groups and periodic PUSCH, PUCCH or combinations of periodic PUCCH/PUSCH may be used to transmit UCIs for multiple DL component carriers for type 2 UCI groups. This is referred to as step 2 of the two step process for asymmetric configurations.

WTRU may receive signalling e.g., radio resource controller (RRC) signalling from an eNodeB that indicates the WTRU-specific UL primary component carrier in which UCIs are transmitted by WTRU. The WTRU may transmit CQI, PMI, RI, ACK/NACK and/or SR via PUCCH in the indicated UL primary component carrier.

The eNodeB may configure a periodic PUSCH based feedback mode for the WTRU to transmit UCIs for multiple DL component carriers. In this case, the WTRU may transmit CQI, PMI, RI, ACK/NACK and/or SR via PUSCH in the indicated UL primary component carrier.

The WTRU may receive a UL grant which indicates a request for an aperiodic PUSCH report using a “CQI request” bit or the like in the UL grant. The “CQI request” bit may request a UCI report for multiple DL component carriers by WTRU. Alternatively, the “CQI request” bit may request a UCI report for configured DL component carriers by WTRU. The “CQI request” bit may also request a UCI report for activated DL component carriers by WTRU. A carrier indication field (CIF) field may also be used to indicate the applicable DL component carriers for the UCI report. The CIF may be sent in the UL grant. The value of the CIF field may indicate how many DL component carriers that the UCIs are being sent for or it may indicate (e.g., as an index or offset) which DL component carrier the UCI is being sent for. For example, if the CIF field was set to 3, then it may mean that the UCI report may include 3 DL component carriers or it may mean that the UCI report may include the third DL component carrier. DL component carriers may be ranked in order for UCI reporting purposes.

In general, UL and DL carriers may be associated with each other as a pair or group for UCI transmissions. The WTRU may transmit an UCI group that may include one or multiple UCIs depending on the techniques used for transmission. For example, if UCI bundling is used to bundle multiple UCIs and create a single UCI for a UCI group, then a single but bundled UCI may be transmitted by the WTRU. Time division multiplexing may be used to transmit multiple UCIs for multiple DL component carriers. The WTRU may transmit a UCI group with multiple UCIs with each UCI being transmitted in different times, subframes or report instances. Frequency or code division multiplexing may also be used to transmit multiple UCIs for multiple DL component carriers. The WTRU may transmit an UCI group with multiple UCIs simultaneously with each UCI being transmitted using different codes e.g., different cyclic shift codes, orthogonal codes, cover codes, frequency resources, resource blocks (RBs), or multiple PUCCHs.

Disclosed now are WTRU UCI transmission methods using a single UL primary component carrier or multiple UL component carriers and PUCCH. PUCCH may be used to transmit UCIs for both type 1 and type 2 UCI groups in multiple UL carriers. That is, the WTRU may use PUCCH for UCI transmission of symmetric and asymmetric component carrier configurations. In order to reduce overhead, latency, delay, or other similar issues, the WTRU may bundle UCIs into fewer UCIs or a single UCI and may transmit in one or multiple subframes using one or multiple PUCCHs in one or multiple UL carriers. For example, the WTRU may transmit multiple UCIs in one subframe using one PUCCH or PUSCH in one UL component carrier. The WTRU may transmit multiple ACK/NACKs in one subframe using one PUCCH in a single UL component carrier. The WTRU may transmit multiple CQI/PMIs or RIs in multiple subframes using one PUCCH in a single UL component carrier.

In general, for a type 2 UCI group or asymmetric configuration, PUCCH may not have enough capacity to accommodate UCIs for multiple DL component carriers in carrier aggregation. UCIs for type 2 UCI group may therefore be transmitted by the WTRU using UCI bundling; carrier bundling; different multiplexing techniques such as time division multiplexing (TDM), code division multiplexing (CDM), frequency division multiplexing (FDM) or a combination of time, code and frequency multiplexing; joint coding of UCIs including joint coding of multiple ACK/NACK/DTX states, channel selection or resource selection, large payload PUCCH format or a combination of the above techniques. Single or multiple PUCCHs may be used by the WTRU for UCI transmission.

In a first PUCCH method, the WTRU may transmit UCI for each type 1 UCI group, and may bundle UCIs into a single UCI and transmit the bundled UCI for each type 2 UCI group. WTRU may transmit the non-bundled UCI in each type 1 UL component carrier for the associated type 1 DL component carrier. The WTRU may transmit all or partial UCIs for type 2 DL component carriers in the same type 2 UCI group. If the WTRU performs a full UCI bundling, the WTRU may transmit a single bundled UCI in a type 2 UL component carrier for the associated type 2 DL component carriers.

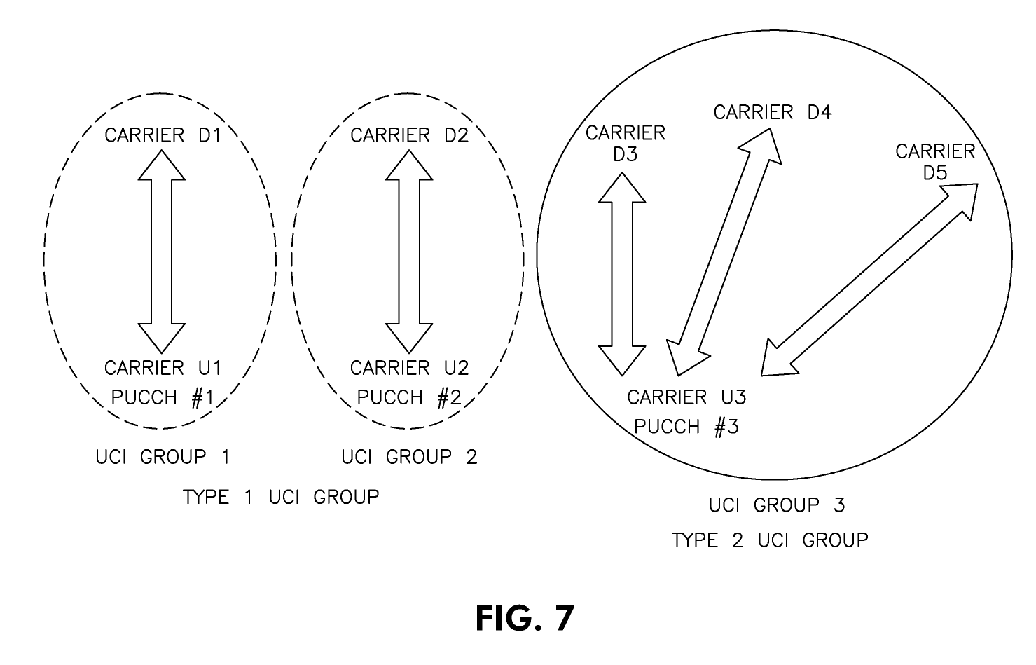

Examples are described and illustrated in FIG. 7. In a first example, the WTRU may transmit one UCI for Carrier D1 in Carrier U1 for UCI group 1. In a second example, the WTRU may transmit one UCI for Carrier D2 in Carrier U2 for UCI group 2. In yet another example, the WTRU may transmit one or multiple UCIs for Carrier D3, Carrier D4 and Carrier D5 in Carrier U3 for UCI group 3. If the WTRU bundles UCIs for Carrier D3, Carrier D4 and Carrier D5, then the WTRU may transmit only one single bundled UCI for Carrier D3, Carrier D4 and Carrier D5 in Carrier U3. UCI bundling may be performed by an exclusive OR (XOR) of multiple ACK/NACK bits, or by averaging or selecting of multiple CQIs, PMIs or RIs.

As shown, the WTRU may use PUCCH to carry UCI for each type 1 and type 2 UCI group in each type 1 or type 2 UL component carrier. For type 2 UCI groups, the WTRU may use multiple methods to bundle the UCI.

In a PUCCH bundling method example, the WTRU may bundle multiple ACK/NACK into a single ACK/NACK. First, the WTRU may bundle multiple ACK/NACKs for multiple DL component carriers in each type 2 UCI group to produce a single ACK/NACK. This may be referred to as full bundling. The number of ACK/NACKs that may be bundled may be limited to two if a maximum of two DL component carriers may be associated in a type 2 UCI group as described in AR2 above. In general, the greater the number of ACK/NACKs that are bundled, the greater the degradation in performance. This may occur if at least one of the ACK/NACKs is a NACK, since the NACK may cause a hybrid automatic repeat request (HARQ) retransmission. This may degrade throughput and performance. By limiting the number of ACK/NACKs for bundling, it may reduce the HARQ retransmission rates and enhance performance and throughput. This may be referred to as partial bundling.

For bundled ACK/NACK transmission corresponding to multiple UL component carriers, a DL component carrier is designated as a “controlling” carrier for determining a PUCCH resource which is aperiodic and dynamically assigned. A physical downlink control channel (PDCCH) corresponding to the designated or controlling carrier is referred to as a controlling PDCCH. A PUCCH resource that is used for ACK/NACK transmission may be linked to and determined by the designated or controlling PDCCH's Control Channel Elements (CCE) address. Alternatively, DL component carriers of type 2 UCI groups may be ranked in priority. The controlling carrier may be defined as the highest priority carrier which received a PDCCH in its control region such as subframe n−4, where n is the subframe number referring to when the aperiodic PUCCH may be transmitted. For example, if a UCI group is made of DL component carriers (D1, D2, D3 and D4) and priority is defined from highest to lowest (D4>D3>D2>D1) and PDCCH is received in, for example, subframe n−4 for D3 and D2 only, the PDCCH CCE address of carrier D3 may define the PUCCH resource in, for example, subframe_n for bundled ACK/NACK transmission.

The following example procedure may be used by the WTRU for ACK/NACK carrier bundling. For ACK/NACK transmission, a PUCCH resource index may be linked to a PDCCH CCE index. For multiple DL component carriers such as a type 2 UCI group, a DL component carrier may be designated as a “controlling” DL component carrier for determining which PUCCH resource to use. Accordingly, a PDCCH may be designated as a “controlling” PDCCH for determining which PUCCH resource to use. For frequency division duplex (FDD), the WTRU may use PUCCH resource n_{PUCCH}⁽¹⁾ for transmission of bundled HARQ-ACK/NACK for multiple component carriers in subframe n. For a PDSCH transmission indicated by the detection of a corresponding PDCCH for the designated or controlling DL component carrier or controlling PDCCH in subframe n−4, or for a PDCCH indicating downlink semi-persistent scheduling (SPS) release for the designated or controlling DL carrier in subframe n−4, the WTRU may use n_{PUCCH}⁽¹⁾=n_{CCE}+N_{PUCCH}⁽¹⁾, where n_{CCE} is the number of the first CCE used for transmission of the corresponding DCI assignment corresponding to the designated or controlling DL component carrier and N_{PUCCH}⁽¹⁾ is configured by higher layers. Alternatively, for a PDSCH transmission where there is no PDCCH detected corresponding to the designated or controlling DL component carrier in subframe n−4, the value of n_{PUCCH}⁽¹⁾ is determined according to a higher layer configuration.

In another PUCCH bundling method example, the WTRU may bundle multiple CQIs into a single CQI. Multiple CQIs for multiple DL component carriers in each type 2 UCI group may be averaged by the WTRU to produce a single CQI. Alternatively, signal-to-interference+noise ratios (SINRs) for multiple DL component carriers in each type 2 UCI group may be computed and averaged by the WTRU to produce a single CQI. The WTRU may use statistics other than averaging such as, but not limited to, the smallest CQI values from a set of CQI that are to be reported. In another CQI method, a single wideband CQI for multiple DL component carriers in each type 2 UCI group may be produced by the WTRU if wideband CQI is reported. In yet another CQI method, a CQI per M selected sub-bands for multiple DL component carriers in each type 2 UCI group may be computed by the WTRU if WTRU selected sub-band CQI reporting is used.

In another PUCCH bundling method example, the WTRU may bundle multiple PMIs or RIs into a single PMI or RI. Multiple PMIs for multiple DL component carriers in each type 2 UCI group may be averaged by the WTRU to produce a single PMI. Alternatively, SINRs or the like for multiple DL component carriers in each type 2 UCI group may be computed and averaged by the WTRU to produce a single PMI. The WTRU may use several criteria to produce an averaged PMI such as sum-rate, channel capacity, SINR, mean square error (MSE), or other similar criteria.

The WTRU may bundle the CQI to reflect the bundling of the PMI.

For example, if PMI is bundled, the WTRU may report the CQI corresponding to the reported bundled PMI. In another example, the WTRU may bundle PMIs such that a PMI from the multiple PMIs is selected maximizing the smallest CQI from the PMI set to be bundled. That is, when the bundled PMI is represented by the selected PMI, the CQI reported is the CQI corresponding to the reported PMI (i.e., the selected PMI). The WTRU may bundle PMIs using a number of techniques including, but not limited to, using an average PMI among multiple PMIs, a median PMI in a PMI set or a selected PMI among multiple PMIs that maximizes the CQI and other similar measures. This applies similarly for RI.

A single wideband PMI for multiple DL component carriers in each type 2 UCI group may be produced by the WTRU if wideband PMI is reported.

A single RI for multiple DL component carriers in each type 2 UCI group may be produced by the WTRU. The value of RI may be the same in the same UCI group but may be different for different UCI groups. For example, RI#1 may be for type 2 UCI group#1 and RI#2 may be for type 2 UCI group #2. RI#1 may not be necessarily equal to RI#2 depending on channel conditions, geometry and other parameters or considerations.

In summary, the WTRU may use full bundling or partial bundling for PUCCH UCI transmissions. The WTRU may bundle multiple UCIs into single or a fewer number of UCI bundles. The bundling may contain different combinations of UCI.

In a PUCCH multiplexing example, the WTRU may transmit the UCI for each type 1 UCI group and transmit multiple UCIs in multiple subframes for each type 2 UCI group using PUCCH. In this method, the WTRU may send non-bundled UCI for each type 1 UCI group in different timeslots or subframes and send multiple non-bundled UCIs in multiple subframes for each type 2 UCI group. The WTRU may apply subframe offsets to type 2 UCI group for transmitting multiple non-bundled UCIs. As an example, if M non-bundled UCIs are to be sent for a type 2 UCI group, then for each non-bundled UCI, the WTRU may have a subframe offset Δ for reporting with respect to the UCI transmission subframe for type 1 UCI group. UCI#1, UCI#2, UCI#M for type 2 UCI group may have an offset of Δ₁,Δ₂, . . . ,Δ_{M} subframes in reporting with respect to UCI transmission for type 1 UCI group. The WTRU may use PUCCH to carry UCI for each type 1 and type 2 UCI group in each type 1 or type 2 UL component carrier.

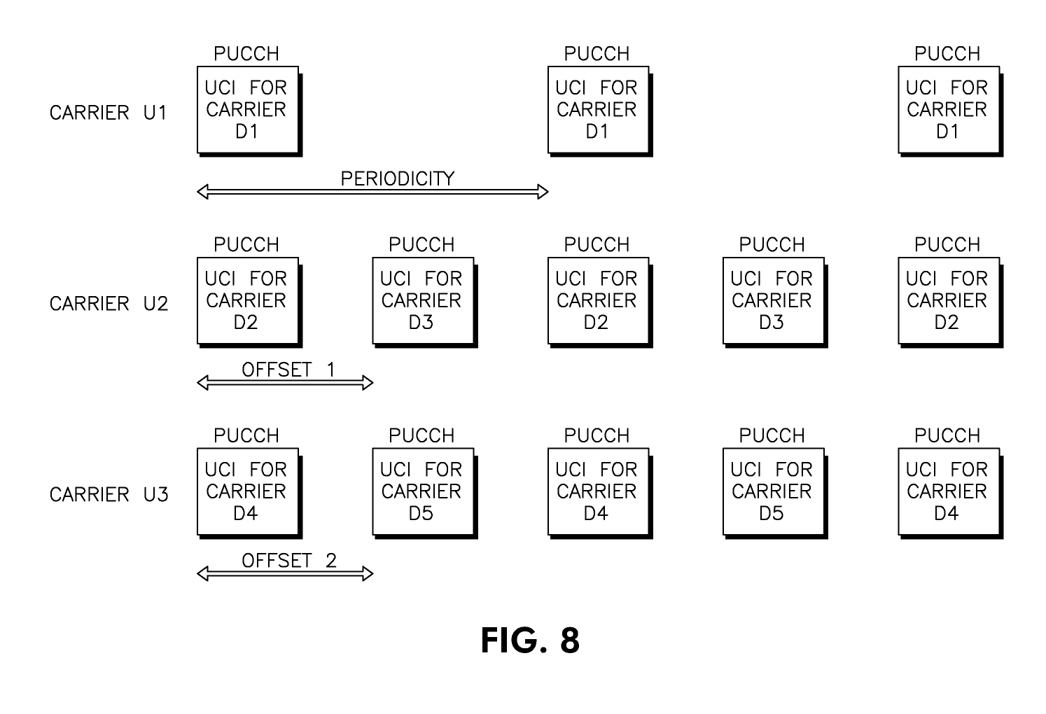

Referring now to FIGS. 5 and 8, there is shown an example timing diagram corresponding to a PUCCH multiplexing example. As shown in FIG. 8, for Carrier D1, the WTRU may transmit the UCI periodically via PUCCH in Carrier U1 for UCI group 1. Carrier D1 or UCI group 1 may be a reference to other carriers or UCI groups when a timing offset is applied. The WTRU may transmit two UCIs, one UCI for Carrier D2 and the other UCI for Carrier D3, periodically in Carrier U2 for UCI group 2 with an offset 1 with respect to UCI transmission time corresponding to Carrier D1 (zero offset in this example) and offset 2 with respect to the UCI transmission corresponding to Carrier D2, respectively. That is, offset 1 corresponds to a time offset between Carrier D1 and Carrier D2 and offset 2 corresponds to a time offset between Carrier D2 and Carrier D3. The WTRU may transmit two UCIs, one UCI for Carrier D4 and the other UCI for Carrier D5, periodically in Carrier U3 for UCI group 3 with offset 1 with respect to UCI transmission time corresponding to Carrier D1 (zero offset in this example) and offset 2 with respect to the UCI transmission corresponding to Carrier D4. That is, offset 1 corresponds to a time offset between Carrier D1 and Carrier D4 and offset 2 corresponds to a time offset between Carrier D4 and Carrier D5. The WTRU may apply different offsets or non-zero offsets such that the PUCCH transmitted by the WTRU in different UL component carriers may not align with each other and PUCCH transmission for multiple UCIs may not occur at the same time in the same subframe. The WTRU may transmit the PUCCH at different times with different proper offsets. This may reduce Peak-to-Average Power Ratio (PAPR).

In a PUCCH bundling and multiplexing example, the WTRU may transmit the UCI for each type 1 UCI group and bundle UCIs into fewer UCIs and transmit the bundled UCIs in multiple subframes for each type 2 UCI group using PUCCH. In order to reduce the time delay due to transmitting multiple UCIs in multiple subframes, the WTRU may bundle multiple UCIs into less UCIs and transmit in fewer subframes. Referring back to FIG. 5, the WTRU may bundle and transmit UCI for UCI group 1 and 2 in a single subframe while the WTRU may transmit UCIs for UCI group 3 in multiple subframes. The WTRU may bundle UCIs for UCI group 3 such that UCIs for Carrier D3 and Carrier D4 are bundled and UCI for Carrier D5 is not bundled. Thus only two subframes instead of three subframes may be needed to complete the UCI transmission cycle for UCI group 3. This combines UCI bundling and time division multiplex of bundled and non-bundled UCIs.

In another PUCCH bundling and multiplexing example, the WTRU may transmit UCI for each type 1 UCI group and bundle multiple UCIs into fewer UCIs and transmit in multiple PUCCHs for each type 2 UCI group. The WTRU may transmit non-bundled UCI via periodic PUCCH for each type 1 UCI group and transmit multiple bundled or non-bundled UCIs via periodic PUCCH for each type 2 UCI group. In order to reduce the use of PUCCH resources simultaneously due to transmitting multiple UCIs in multiple PUCCHs, the WTRU may bundle multiple UCIs into less UCIs and transmit fewer PUCCHs. Referring back to FIG. 4, the WTRU may transmit UCI for UCI group 1 and 2 in a single PUCCH while transmit UCIs for UCI group 3 in multiple PUCCHs. The WTRU may bundle UCIs for UCI group 3 such that UCIs for Carrier D3 and Carrier D4 may be bundled and UCI for Carrier D5 may not be bundled. Thus only two PUCCHs may be needed in Carrier U3 for UCI transmission for UCI group 3. This combines UCI bundling and multiple PUCCH transmission of bundled and/or non-bundled UCIs.

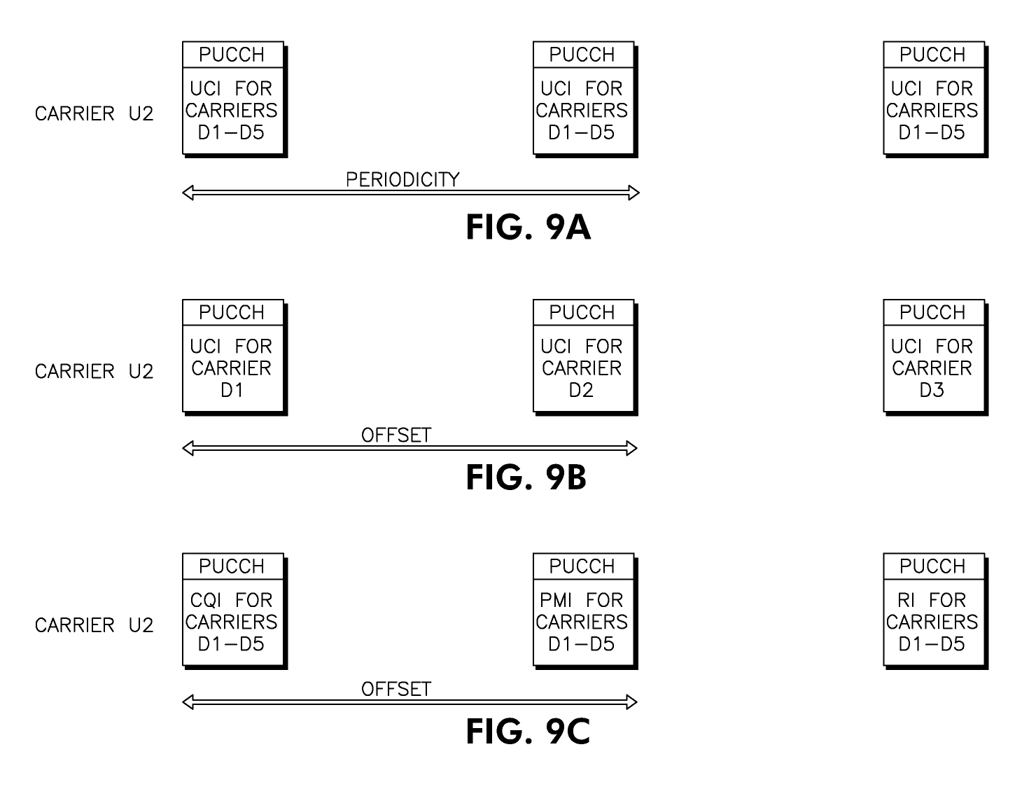

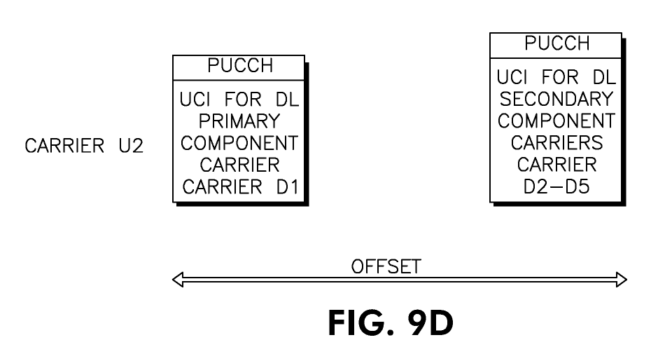

Referring now to FIGS. 6 and 9(a)-(d), there is shown another example timing diagram corresponding to a PUCCH multiplexing example. As shown in FIG. 9(a), the WTRU may transmit the UCIs for Carriers D1-D5 periodically via PUCCH in Carrier U2, which is a UL primary component carrier. In this example, the UCIs for Carriers D1-D5 may have been bundled, multiplexed, jointly coded or a combination thereof. Alternatively, as shown in FIG. 9(b), the WTRU may transmit the UCI for Carrier D1 via a PUCCH in one subframe, Carrier D2 via a PUCCH in a second subframe and so on. Carrier D1, for example, may be a reference as to when or how a timing offset may be applied. Alternatively, as shown in FIG. 9(c), the WTRU may transmit a first type of UCI (i.e., CQI, PMI, RI and others) in a first subframe, a second type in a second subframe and so on.

In another embodiment shown in FIG. 9(d), WTRU may transmit one UCI report for DL primary component carrier and one UCI report for all DL secondary component carriers. For example, as shown in FIG. 6, the DL primary component carrier may be Carrier D1 and the secondary component carriers may be Carriers D2-D5. The UCI report for DL primary component carrier may contain a detailed UCI report including for example, but not limited to, wideband CQI and/or PMI and subband CQIs and/or PMIs, and other UCI information. The UCI report for the DL secondary component carriers may contain only non-detailed UCI report including for example, but not limited to, wideband CQI and/or PMI. The WTRU may transmit the UCI reports for DL primary component carrier and DL secondary component carriers in a UL primary component carrier. The WTRU may transmit the UCI report for DL primary component carrier in one subframe and the UCI report for DL secondary component carriers in another subframe, where both reports are sent via PUCCH. Alternatively, the WTRU may transmit the UCI report for DL primary component carrier in one subframe using PUCCH and the UCI report for DL secondary component carriers in another subframe using PUSCH. Alternatively, the WTRU may transmit the UCI report for DL primary component carrier in one subframe using one PUCCH format or scheme e.g., PUCCH format 2, and the UCI report for DL secondary component carriers in another subframe using another PUCCH format or scheme e.g., DFT-S-OFDM format. Other combinations and variations are possible and are not shown.

Disclosed now are WTRU UCI transmission methods using a single UL primary component carrier or multiple UL component carriers and PUSCH.

If there is PUSCH in the same subframe as a PUCCH, UCIs corresponding to multiple carriers may be bundled, non-bundled, multiplexed, jointly coded or a combination thereof and the WTRU may piggyback/transmit in PUSCH if PUCCH and PUSCH are not configured or allowed to be transmitted in the same subframe.

The WTRU may use aperiodic PUSCH to carry UCIs which correspond to multiple component carriers. In one example, the UCIs carried by the PUSCH may contain the same UCI carried by the PUCCH. The WTRU may use other UCI or UCI report formats that may be carried by aperiodic PUSCH. In another example, the WTRU may periodically transmit UCI using aperiodic PUSCH. The WTRU may decode a PDCCH and check a CQI request bit in the UL grant and report UCI accordingly. Resource allocation for aperiodic PUSCH may be indicated in the PDCCH UL grant.

Disclosed now are WTRU UCI transmission methods using a single UL primary component carrier or multiple UL component carriers and combinations of PUSCH and PUCCH. This may in effect result in parallel transmission of the UCI(s) and concurrent transmission of PUSCH and PUCCH.

In one example, the WTRU may use the PUSCH to transmit UCIs for type 2 UCI group and the PUCCH to transmit UCI for type 1 UCI group. In this case, PUSCH may be used to carry all UCIs for DL component carriers in each type 2 UCI group while PUCCH may be used to carry UCI for DL component carrier in each type 1 UCI group.

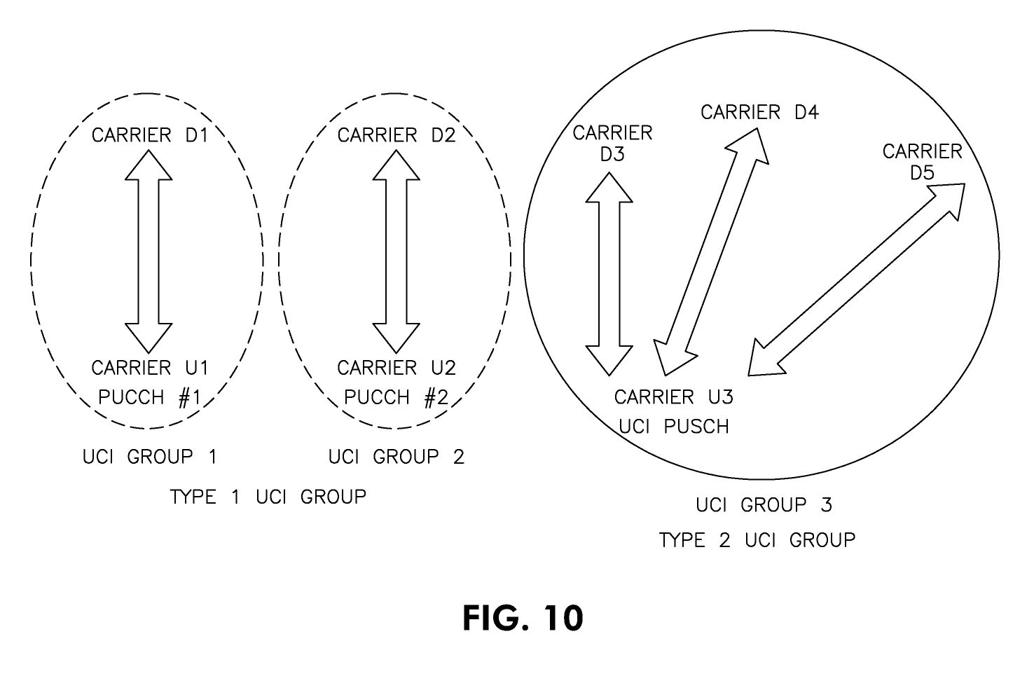

Referring now to FIG. 10, the WTRU may transmit UCIs corresponding to Carrier D1 and Carrier D2 in PUCCH #1 and PUCCH #2 in Carrier U1 and U2, respectively, for each type 1 UCI group. The WTRU may transmit UCIs corresponding to Carrier D3, Carrier D4 and Carrier D5 using PUSCH for type 2 UCI group. The WTRU may or may not bundle UCIs corresponding to Carrier D3, Carrier D4 and Carrier D5. The WTRU may transmit UCI for type 1 UCI group using periodic PUCCH (one for each DL component carrier) and transmit UCI for type 2 UCI group using periodic PUSCH. Periodic PUSCH may be configured via radio resource controller (RRC) signaling or L1/2 control signaling.

In another combination example, the WTRU may use a combination of PUCCH/PUSCH to transmit UCIs for type 2 UCI group and use PUCCH to transmit UCI for type 1 UCI group. The UCIs may bundled, non-bundled, multiplexed, jointly coded or any combination thereof, and may be transmitted in a combined PUCCH and PUSCH simultaneously if PUCCH and PUSCH may be transmitted in the same subframe.

Disclosed now are WTRU UCI transmission methods using a single UL component carrier and PUCCH. The methods and techniques described herein such as, but not limited to, joint coding, bundling, multiplexing and reporting, are applicable this embodiment.

In one example, the WTRU may use PUCCH to transmit UCIs for all DL component carriers for both type 1 and type 2 UCI groups in a single UL component carrier.

If the WTRU uses a single UL component carrier for UCI transmission, a PUCCH may not have enough capacity to accommodate UCIs for all DL component carriers in carrier aggregation. In this case, the UCIs may be transmitted by the WTRU using UCI bundling, carrier bundling, time division multiplexing, code division multiplexing, frequency division multiplexing, joint coding of UCIs, channel or resource selection, large payload PUCCH, multiple PUCCHs or combinations thereof. That is, the WTRU may bundle UCIs into fewer UCIs and transmit in multiple PUCCHs and/or multiple subframes. The WTRU may use this method for large degree asymmetric carrier aggregation such as, for example, 5 DL component carriers and 1 UL component carrier.

For example, in a subframe n, the WTRU may send a UCI for Carrier 1D using PUCCH x and bundle UCIs for Carrier 2D and Carrier 3D and send using PUCCH y. The WTRU may bundle UCIs for Carrier 4D and Carrier 5D and send using PUCCH z in the subframe n+O where O is the reporting offset (in subframes).

Disclosed now are WTRU UCI transmission methods using a single UL component carrier and PUSCH. The methods and techniques described herein such as, but not limited to, joint coding, bundling, multiplexing and reporting, are applicable this embodiment. The WTRU may use PUSCH to transmit UCIs for all DL component carriers for both type 1 and type 2 UCI groups in a single UL carrier.

In one example, the WTRU may use periodic PUSCH to transmit UCI in one UL component carrier such as an UL primary component carrier. The WTRU may transmit UCI in a primary PUSCH. The UL primary component carrier or primary PUSCH may be WTRU specific. This may balance the traffic due to UCI transmissions. Alternatively, UL primary component carrier or primary PUSCH may be cell specific.

Periodic PUSCH may be configured for transmitting UCI via RRC configuration. RRC configuration may include release, setup of periodic PUSCH reporting mode, reporting interval or periodicity, or reporting formats. In conjunction with RRC configuration, PDCCH may be used to indicate the resource size, or resource block (RB) allocation for periodic PUSCH.

As stated herein, periodic PUSCH may be configured via PDCCH for transmitting UCIs. Periodic PUSCH may be activated via PDCCH or medium access control (MAC) control element (CE). Once it is activated, the WTRU may report UCIs periodically using periodic PUSCH resources until it is de-activated via another PDCCH or MAC CE. Periodic PUSCH may also be de-activated implicitly based on some parameters such as traffic conditions. Activation PDCCH may be used to activate periodic PUSCH reporting mode. Periodic PUSCH reporting mode may be configured by RRC. Activation PDCCH or MAC CE may also indicate the resource allocation of periodic PUSCH. De-activation of periodic PUSCH may be done via another PDCCH, MAC CE or implicit deactivation.

Periodic PUSCH may be configured similar to periodic PUCCH. The periodic PUSCH resource may be located at some predetermined location such as Physical Resource Blocks (PRBs) located at the edge of bandwidth adjacent to PUCCH resources for frequency diversity. Hopping may be used for periodic PUSCH for PRB allocation. Alternatively, PRBs allocated for periodic PUSCH resources may be indicated using L1/2 control such as PDCCH signalling or higher layer signalling such as, RRC signalling.

Disclosed now are WTRU UCI transmission methods using a single UL component carrier and combinations of single or multiple PUCCH(s) and PUSCH(s). The methods and techniques described herein such as, but not limited to, joint coding, bundling, multiplexing and reporting, are applicable this embodiment. In one example, a WTRU may use PUCCH to transmit UCIs corresponding to some DL component carriers such as, for example, type 1 UCI group and use PUSCH to transmit UCIs corresponding to some DL component carriers such as type 2 UCI groups in a single UL component carrier.

The WTRU may use combinations of PUSCH and PUCCH to transmit UCIs for all DL component carriers for both type 1 and type UCI groups in one UL component carrier. In this method, the WTRU may transmit part of the UCIs using periodic PUSCH and part of the UCIs using periodic PUCCH but they are transmitted in the same UL component carrier. The WTRU may transmit a UCI corresponding to one DL component carrier using PUCCH while the UCIs corresponding to multiple DL component carriers may be transmitted using PUSCH.

Two options may be considered for this method. With respect to a first option, the WTRU may use a single periodic PUSCH and a single periodic PUCCH transmission to transmit in one UL component carrier or an UL primary component carrier. The WTRU may use a single PUCCH and a single PUSCH to transmit UCI, where PUCCH may be used to transmit UCI corresponding to one DL component carrier and PUSCH may be used to transmit UCIs corresponding to the remaining DL component carriers.

With respect to a second option, the WTRU may transmit a single periodic PUSCH and multiple periodic PUCCHs in one UL carrier. The WTRU may use multiple PUCCHs and a single PUSCH to transmit UCI, where each PUCCH may be used to transmit UCI corresponding to one DL component carrier. The WTRU may use N PUCCHs to transmit UCIs corresponding to N DL component carriers. The WTRU may use a PUSCH to transmit UCIs corresponding to the remaining DL component carriers.

In another example, ACK/NACK for downlink reception of each UCI type 2 group may be sent by the WTRU over the UL component carrier of the UCI group using one or more PUCCH resources according to the following methods. Although these methods assume for simplicity that the maximum number of DL component carriers that may be associated in one UCI group is two, these methods or a subset of then may be used to address more generic cases.

In one method, ACK/NACK of 2 DL component carriers associated with reception at the WTRU occurring at subframe n−4 may be sent by the WTRU over PUCCH format 1b, where the first bit in the PUCCH format 1b is associated with the controlled carrier, and the second bit with the non-controlled carrier. For example, if PDCCH is not received for the controlled carrier and PDCCH is received for the non-controlled carrier, and the associated downlink grant was correctly received on the PDSCH, the PUCCH format 1b will be discontinuous transmission (DTX) on the first bit, and ACK on the second bit. If more than 1 codeword is present, the following rules may apply. If both codewords are received correctly, an ACK may be sent in the appropriate bit of PUCCH 1b as described earlier. If one of the codewords is not received, a NACK may be sent in the appropriate bit of PUCCH 1b as described earlier. If the PDCCH is not received, the appropriate bit of PUCCH 1b may be DTX.

Alternatively, ACK/NACK of 2 DL carriers associated with reception at the WTRU occurring at subframe n−4 may be sent by the WTRU over 2 consecutive rotations of the cyclic shift (CS) using PUCCH format 1a. For PUCCH, a twelve rotation of the cyclic shift is available, but LTE networks typically use a 6 rotation or 6 CSs. For example, if based on the starting CCE of the PDCCH, the PUCCH resource is cover sequence 1 and phase rotation 7, both PUCCH resources cover sequence 1 and phase rotation 7 and cover sequence 1 and phase rotation 8 may be used. The first PUCCH resource would be associated with the controlled carrier allocation.

In another example, ACK/NACK for downlink reception of each UCI type 2 group may be sent by the WTRU over the UL component carrier of the UCI group using one or more PUCCH resources or a new PUCCH format according to the following methods. These methods are described in the context of the maximum number of DL component carriers that may be associated in one UCI group. For example, the maximum number may be 3 or 4.

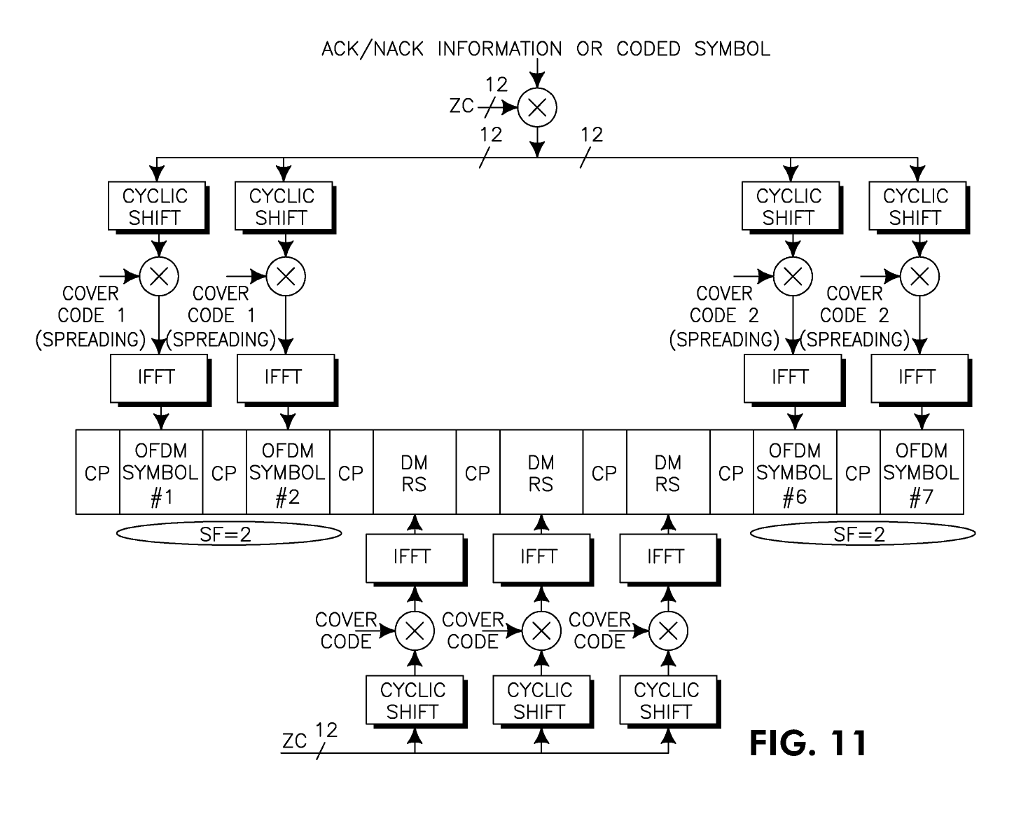

In one method, a new PUCCH format using 2 or more symbols, called PUCCH format 1d, may be used by the WTRU to carry more than two ACK/NACKs e.g., 4 ACK/NACK bits under the same PUCCH resource. The ACK/NACK bits may be information bits/symbols or coded bits/symbols. The ACK/NACK bits may also be the bits representing the ACK/NACK/DTX states with or without joint coding. The new format may be used to send 2 or more symbols (or 4 bits or more) on the same PUCCH resource. One approach may be to map the first symbol (information symbol or coded symbol if coding is used to fill the ACK/NACK bits in the PUCCH physical resource) in the first slot in, for example in an LTE system (Orthogonal Frequency Division Multiple Access (OFDMA) symbol 1, 2, 6 and 7) as shown in FIG. 11 and a second information symbol in the second slot (OFDMA symbol 8, 9, 13 and 14). FIG. 11 shows the first timeslot of a subframe. Another approach may be to reduce the spreading factor (SF) of a time domain orthogonal code or cover code in PUCCH format 1a or 1b to accommodate more ACK/NACK bits. The number of ACK/NACK bits that may be sent is doubled if the SF of the time domain spreading code or orthogonal cover code is reduced by half (or reduced to SF=2 from 4). The number of ACK/NACK bits that may be sent is quadrupled if the SF of the time domain spreading code or orthogonal cover code is reduced to SF=1 or no spreading from 4. For SF=2, this approach may map the first ACK/NACK symbol (either information symbol or coded symbol) in Orthogonal Frequency Division Multiple Access (OFDM) symbols 1 and 2 and map the second information symbol in OFDM symbols 6 and 7 in the first slot of a subframe as shown in FIG. 11 and repeat the first information symbol in OFDM symbols 8, and 9 and repeat the second information symbol in OFDM symbols 13 and 14 in the second slot of the same subframe.

If more than one codeword may be received for a given component carrier, the ACK/NACK of the different codewords are merged as described herein. For example, the method described herein where the ACK/NACK of 2 DL component carriers associated with reception at the WTRU occurring at subframe n−4 may be sent by the WTRU over PUCCH format 1b, where the first bit in the PUCCH format 1b is associated with the controlled carrier, and the second bit with the non-controlled carrier, may be used.

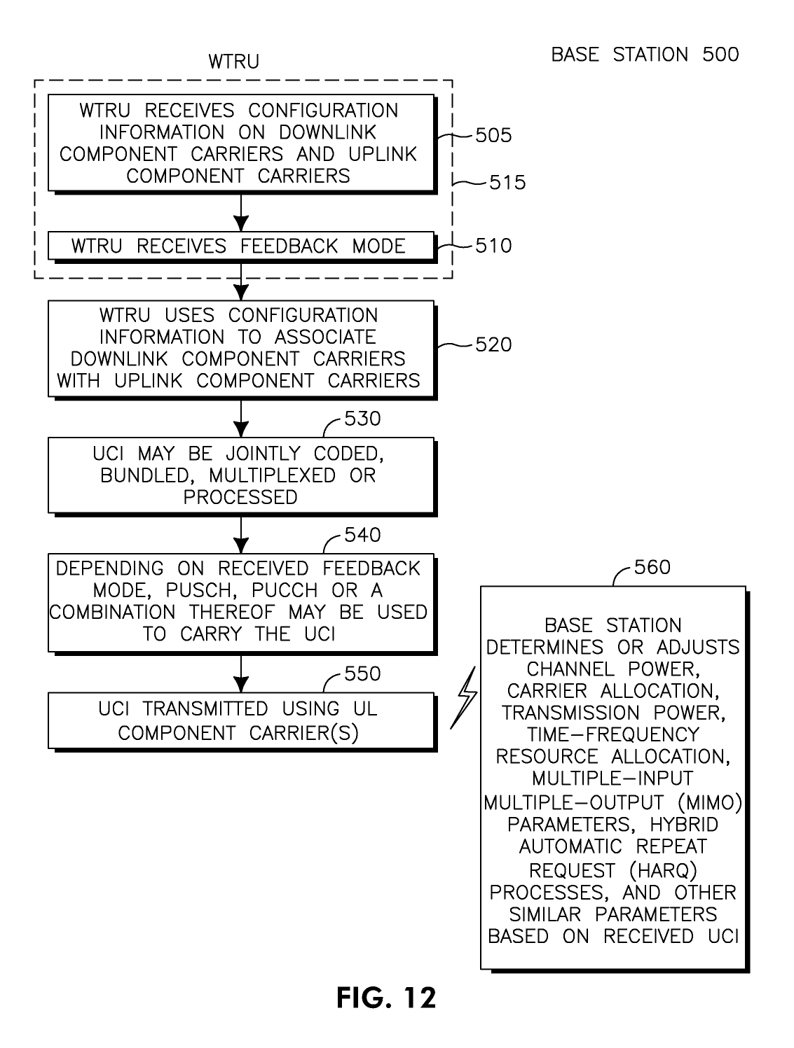

Referring to FIG. 12, there is shown an example flowchart 500 for transmitting UCI from a WTRU to a base station. The WTRU receives configuration information regarding DL component carriers and UL component carriers (505). The WTRU may also receive feedback mode information from the base station (510). Alternatively, the feedback mode information may be part of the configuration information (515). The WTRU uses the configuration information to associate the DL component carriers with the UL component carriers (520). The UCI corresponding to the associated DL component carriers-UL component carriers may then be jointly coded, bundled, multiplexed or processed as described hereinbefore by the WTRU to minimize UCI traffic (530). Based on the feedback mode, resource allocation and scheduling, a PUSCH, PUCCH or a combination thereof may be used by the WTRU to carry the UCI (540). The PUSCH, PUCCH or a combination thereof may then be transmitted by the WTRU using the associated multiple UL component carrier(s) (550). The base station acts in accordance with the type of UCI received (560). For example, the base station may make determinations or adjustments to channel power, carrier allocation, transmission power, time-frequency resource allocation, multiple-input multiple-output (MIMO) parameters, hybrid automatic repeat request (HARQ) processes, and other similar parameters. The flowchart is representative and other combinations with or without the other features and elements and in different sequences are within the scope of the disclosure.

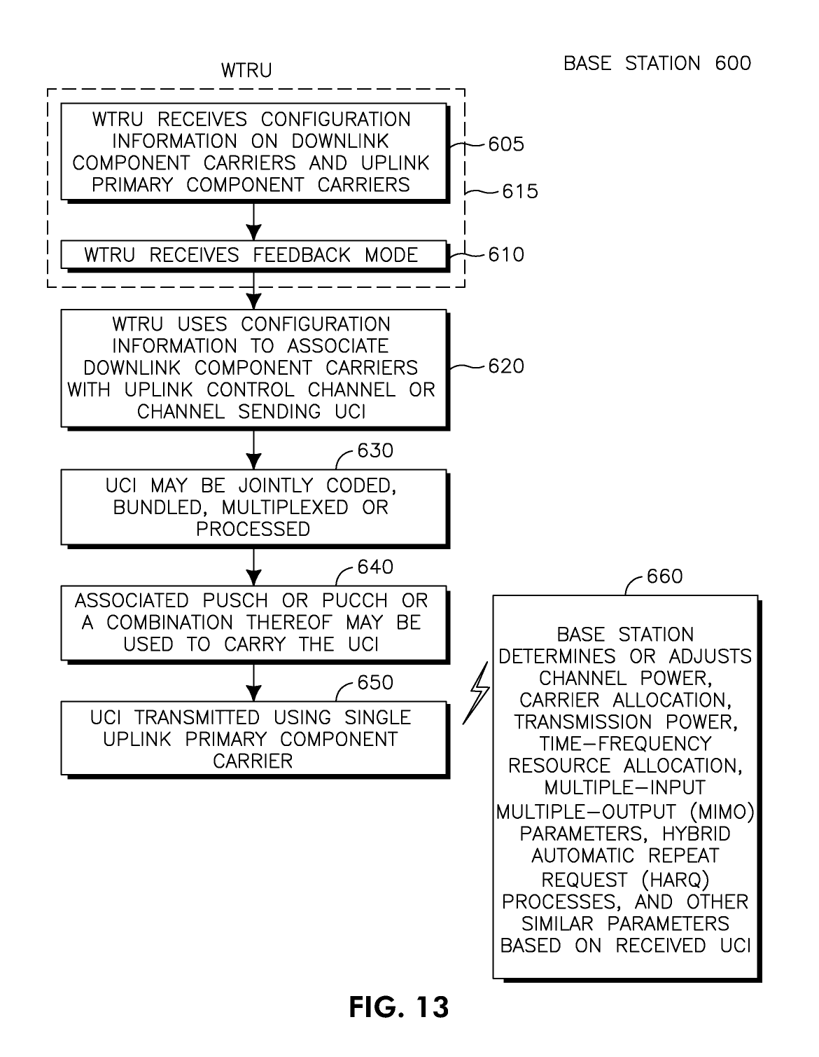

Referring to FIG. 13, there is shown an example flowchart 600 for transmitting UCI from a WTRU to a base station. The WTRU receives configuration information regarding DL component carriers and an UL primary component carrier (605). The WTRU may also receive feedback mode information from the base station (610). Alternatively, the feedback mode information may be part of the configuration information (615). The WTRU uses the configuration information to associate the DL component carriers with a control channel or channel carrying UCI (620). The UCI corresponding to the associated DL component carriers-UL component carriers may then be jointly coded, bundled, multiplexed or processed as described hereinbefore by the WTRU to minimize UCI traffic as discussed herein (630). The associated PUSCH, PUCCH or a combination thereof may be used by the WTRU to carry the UCI (640). The PUSCH, PUCCH or a combination thereof may then be transmitted by the WTRU using the associated multiple UL component carrier(s) (650). The base station acts in accordance with the type of UCI received (660). For example, the base station may make determinations or adjustments to channel power, carrier allocation, transmission power, time-frequency resource allocation, multiple-input multiple-output (MIMO) parameters, hybrid automatic repeat request (HARQ) processes, and other similar parameters. The flowchart is representative and other combinations with or without the other features and elements and in different sequences are within the scope of the disclosure.

While the present invention has been described in terms of the embodiments, other variations which are within the scope of the invention will be apparent to those skilled in the art.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A wireless transmit/receive unit (WTRU) comprising:
an antenna;
a transceiver, operatively coupled to the antenna; and
a processor, operatively coupled to the transceiver;
the transceiver configured to receive, in a subframe n−4, a plurality of codewords on a plurality of physical downlink shared channels (PDSCHs) on a plurality of downlink component carriers; and
the processor configured to send, in subframe n using a physical uplink control channel (PUCCH) format 1b transmission, an indication as to whether each of the plurality of codewords is being acknowledged (ACK) or negatively acknowledged (NACK); and
the transceiver is configured to substantially simultaneously transmit a first PUCCH transmission on a first uplink carrier and a second PUCCH transmission on a second uplink carrier, wherein the first PUCCH transmission is associated with a first group of downlink component carriers and the second PUCCH transmission is associated with a second group of downlink component carriers.

2. The WTRU of claim 1, wherein the PUCCH format 1b has two bits.

3. The WTRU of claim 1, wherein the transceiver is further configured to transmit a PUCCH having a format different than PUCCH format 1, PUCCH format 1b, PUCCH format 2, PUCCH format 2a and PUCCH format 2b, wherein the PUCCH having the different format is configured to send uplink control information for a plurality of downlink component carriers.

4. The WTRU of claim 3, wherein the different PUCCH format is used instead of PUCCH format 1b when ACK or NACK information for more than two component carriers is to be transmitted.

5. The WTRU of claim 1, wherein the transceiver is further configured to receive an uplink grant having a channel quality indicator (CQI) request, wherein the CQI request is configured with a plurality of downlink component carriers, wherein the processor is configured in response to the CQI request to send CQI information for the configured plurality of downlink component carriers.

6. A method performed by a wireless transmit/receive unit (WTRU), the method comprising:
receiving, by the WTRU in a subframe n−4, a plurality of codewords on a plurality of physical downlink shared channels (PDSCHs) on a plurality of downlink component carriers; and
transmitting, by the WTRU in subframe n using a physical uplink control channel (PUCCH) format 1b transmission, an indication as to whether each of the plurality of codewords is being acknowledged (ACK) or negatively acknowledged (NACK); and
transmitting, by the WTRU substantially simultaneously, a first PUCCH transmission on a first uplink carrier and a second PUCCH transmission on a second uplink carrier, wherein the first PUCCH transmission is associated with a first group of downlink component carriers and the second PUCCH transmission is associated with a second group of downlink component carriers.

7. The method of claim 6, wherein the PUCCH format 1b has two bits.

8. The method of claim 6 further comprising:
transmitting, by the WTRU, a PUCCH having a format different than PUCCH format 1, PUCCH format 1b, PUCCH format 2, PUCCH format 2a and PUCCH format 2b, wherein the PUCCH having the different format is configured to send uplink control information for a plurality of downlink component carriers.

9. The method of claim 8, wherein the different PUCCH format is used instead of PUCCH format 1b when ACK or NACK information for more than two component carriers is to be transmitted.

10. The method of claim 6 further comprising:
receiving, by the WTRU, an uplink grant having a channel quality indicator (CQI) request, wherein the CQI request is configured with a plurality of downlink component carriers, wherein in response to the CQI request transmitting by the WTRU CQI information for the configured plurality of downlink component carriers.
